(19) United States
(12) Patent Application Publication
(10) Pub. No.: US 2014/0190221 A1
(43) Pub. Date: Jul. 10, 2014

(54) Key Organizing System

(71) Applicants: Hong Jiang, Westfield, NJ (US); Benjamin Jiang Cymbala, Westfield, NJ (US)

(72) Inventors: Hong Jiang, Westfield, NJ (US); Benjamin Jiang Cymbala, Westfield, NJ (US)

(21) Appl. No.: 14/149,385

(22) Filed: Jan. 7, 2014

Related U.S. Application Data
(60) Provisional application No. 61/750,338, filed on Jan. 8, 2013.
(60) Provisional application No. 61/792,132, filed on Mar. 15, 2013.

(51) Int. Cl. A47G 29/10; G09F 3/00; E05B 65/52

(52) U.S. Cl. CPC A47G 29/10; E05B 65/52; G09F 3/00
USPC 70/57; 211/85.9; 40/299.01; 206/525

(57) ABSTRACT

The current disclosure describes and teaches a key organizing system which may include one or more key holder assemblies attached to a key organizer. Each key holder assembly forms a tree structure through the fastening mechanisms and the attachment assemblies of key holders. The tree structure is dynamically configured to reflect the relationship of the keys to a property. Keys are attached to the tree structure which facilitates the organization of the keys. The key organizer may include one or more swing sheets. Each swing sheet may include one or more swing hangers. The current invention helps owners or managers of one or multiple residential or commercial properties to better organize keys to their properties by mapping the relationship of the keys to a tree structure and storing the keys accordingly.

### CLAIM OF PRIORITY

This application claims priority to U.S. Provisional Application 61/750,338 filed on Jan. 8, 2013 and to U.S. Provisional Application 61/792,132 filed on Mar. 15, 2013, the contents of both are herein incorporated by reference in their entirety.

### FIELD OF THE INVENTION

The invention relates to a mechanical device that helps users to manage and organize keys for one or multiple residential or commercial properties.

### BACKGROUND OF THE INVENTION

In many cases, owners and managers of one or multiple residential or commercial properties need to keep track of and organize the keys for such properties. However, sometimes the properties—and thus the corresponding keys—have complex tiered relationships, making the organizing efforts more difficult. For example, a manager of an apartment building may need to organize a large number of keys for not only the apartments, which may differ in sizes and format, but also for the individual rooms within the apartments and for public places such as laundry rooms. It is very challenging for the manager to keep track of all the keys, and access specific keys promptly and accurately.

Conventional key accessories, such as key boxes and key cabinets, do not take into account the relationship structure of the keys. Instead the keys are organized in rows, which typically bear no resemblance to the relationships of the properties which correspond to the keys. Therefore, using the conventional key accessories, it is difficult for users to remember which key is for what property, room, or car. It is also difficult to share keys among one or multiple people due to the lack of clear logic in the organization of the keys. In addition, most of these key boxes or cabinets on the market require a continuous upright position so the keys can hang properly. The keys can easily fall out if the key boxes or cabinets are turned upside down or sideways. Therefore, these key boxes or cabinets are generally not portable. Additionally, they are typically limited by a prefixed number of keys. The number of hooks to hang the keys is pre-set during manufacturing. A user cannot add the number of hooks or re-arrange the configuration of the hooks.

Some inventions have been directed to mechanical devices that help to organize keys. For example: U.S. Pat. No. 6,698,854 ('854 patent) discloses a key organizer having a housing with a first section and a second section which are pivotally connected. First and second drums are rotatably mounted on axles within a cavity of the housing. A first belt is engaged with the first and second drums and has a plurality of suspension points for hanging articles thereon. A drive mechanism is connected to one of the drums for rotating one of the drums to cause rotation of the belt. A switching device is connected to the drive mechanism for selectively continuously activating the drive mechanism. Third and fourth drums are mounted onto the axles in spaced relation to the first and second drums. A second belt engages these drums. The drive mechanism has a gear train with a drive gear and additional gears which matingly engage the drive gear. A locking mechanism locks the first and second sections together. A light can be mounted onto one of the first and second sections for illuminating the housing cavity.

However, it should be noted that neither the '854 patent herein listed, nor any other patents or publications, addresses all the issues raised above. In essence, there is a strong unmet need for a key organizing system that organizes keys based on the tiered relationship of the properties that correspond to the keys. In addition, it is desirable for a key organizer to be easy to access and easy to add new key attaching mechanisms. The current invention fulfills the needs.

In summary, various implements are known in the art, but fail to address all of the problems solved by the invention described herein. Several embodiments of this invention are illustrated in the accompanying drawings and will be described in more detail herein below.

### SUMMARY OF THE INVENTION

The present invention is a key organizing system that helps owners or managers of one or multiple residential or commercial properties to better organize keys to their properties. Similarly, this invention helps garage owners, hotel managers, and campus managers who are in possession of many keys. More specifically, the present invention supports the inherent relationship structure of the keys by providing a labeling system and by enabling easy attachment and detachment of key chains.

One central component of the current invention is a key holder assembly, which may include one or more key holders. The key holder assembly can be configured to represent the tiered structure of the keys to the properties by connecting a key holder to another key holder, and connecting keys to the key holders. Each key holder may comprise a label area or a labeling block having at least one label; a fastening mechanism attached to a top of the label area or labeling block; and the attachment assembly having at least one attachment point. The fastening mechanism is preferably a snap hook or a carabiner that is releasable, but may also be other mechanisms. The design of the attachment assembly of the key holder may vary according to specific needs. By connecting one or more key holders (second tier) to another key holder (first tier), it creates two tiers. Similarly, one can connect one or more key holders (third tier) to a second tier key holder, thus creating three tiers in the tree structure. Keys hang off the tree structure of the key holder assembly. The key holder assembly can take on the shape of a tree of any breadth and depth which is described through the labeling system.

The current invention may also include a key organizer comprising a swing hanger having a hanger rack swingably connected to a first hinge, the hanger rack having the hanger attachment assembly disposed on the hanger rack. The hanger attachment assembly of the hanger rack and the attachment assembly of the key holder may be different. The key organizer may also include a swing sheet against which the swing hanger may be aligned. There may also be multiple swing sheets that are aligned in parallel for easy storage. In addition, the key organizer may further include a container box, which may be used to enclose the swing hangers and swing sheets. The container box may be portable and/or wall mountable.

The current invention teaches a key organizing system that consists of a key organizer, and one or more key holder assemblies. The releasable fastening mechanism of the first tier key holder of a key holder assembly may attach to the hanger attachment assembly of the swing hanger. A hanger attachment assembly has one or more hanger attachment points. More particularly, it is preferred that the fastening mechanism of the key holder attaches to the hanger attachment point and conforms to the shape of the hanger attachment point of the swing hanger in a manner which minimizes movement of the fastening mechanism in relation to the hanger rack.

In general, the present invention succeeds in conferring the following, and others not mentioned, desirable and useful benefits and objectives.

The key holder assembly can be configured to closely represent the tiered structure of the keys to the properties by connecting a key holder to another key holder, and connecting keys to the key holders, thus forming the key holder assembly with the tier structure. The key holder assembly can take on the shape of a tree of any breadth and depth which is described through the labeling system.

The key organizer can be highly portable. A user can carry all the keys in the container box with him. Even if the key organizer incur much movement such as being turned upside down or dropped on the ground, the key holders can stay in place through several attachment methods.

The key organizer can be wall mountable and easily releasable. It can be securely mounted to the wall when the container box is locked. When the container box is open, it can be easily removed, and to be put back on the wall at a later time.

A user can re-configure the key holder assembly easily by attaching and detaching the key holders or the keys. Or he can remove a specific key holder from a key holder assembly and later return the key holder to the key holder assembly. Similarly, he can remove a specific key holder assembly from the swing hanger and later return the key holder assembly to the swing hanger. The fastening mechanism on the first-tier key holder enables easy attachment or detachment to the swing hanger, one's belt or a bag. The fastening mechanism on the key holders below the first tier enables easy attachment or detachment to the key holder on a tier above. The adhesive labels can be placed onto the label space of the key holders, indicating the newly formed key structure.

When a key holder is attached to a swing hanger, its fastening mechanism, such as a snap hook or a carabiner, allows little mobility due to the tight fit with the hanger attachment assembly to which the fastening mechanism is attached, regardless of the different weight of the keys on the key holder.

Each swing sheet can swing out individually and each swing hanger can swing out individually for easy viewing and handling of key holders and keys.

### BRIEF DESCRIPTION OF THE DRAWINGS

FIG. 1 shows a key holder assembly wherein the first tier key holder is connected to a number of second tier key holders, demonstrating the tiered structure of the key holders.

FIG. 2 shows a front view of a key organizer including a container box, swing sheets, swing hangers, and hinge pads.

FIG. 3 shows a front view of a key organizing system including a container box, swing sheets, swing hangers, hinge pads, a lock pad, and key holder assemblies.

FIG. 4 shows a front view of the lock pad.

FIG. 5 shows a front view of a key organizer including a container box, a swing sheet, swing hangers, hinge pads, a lock pad, and a wall mounts for the container box.

FIG. 6 shows the wall mounting screw and screw cap.

FIG. 7 shows a side view of how the wall mount works.

FIG. 8 shows a front view of a swing sheet, three hinge pads, and three swing hangers.

FIG. 9 shows a top perspective view of a swing hanger connected to a hinge pad.

FIG. 10 shows the hanger rack of a swing hanger having a hanger attachment assembly consisting of half cylinders and holes.

FIG. 11 shows a top perspective view of a swing hanger, a hinge pad, and a key holder.

FIG. 12 shows top perspective view of a swing hanger connected to a hinge pad, the hanger rack of the swing hanger a hanger attachment assembly consisting of half cylinders and holes

FIG. 13 shows a top perspective view of the hanger rack of a swing hanger connected with a key holder, the hanger rack having an attachment assembly.

FIG. 14 shows the hanger rack of a swing hanger having an attachment assembly.

FIG. 15 shows top perspective view of a swing hanger connected to a hinge pad, the hanger rack of the swing hanger having a half key ring, a key hook and an upside down snap hook or carabiner as attachment points.

FIG. 16 shows a key holder with a snap hook as the fastening mechanism, and a carabiner, a half key ring, a key hook, and a snap hook as attachment points, and a label area with labels.

FIG. 17 shows a key holder with a carabiner as the fastening mechanism, and a carabiner, a half key ring, a key hook, and a snap hook as attachment points, and a label area with labels.

FIG. 18 shows a key holder with a loop as the fastening mechanism, and a carabiner, a half key ring, a key hook, and a snap hook as attachment points as part of the attachment assembly, and a label area with a label.

FIG. 19 shows a key holder with a snap hook as the fastening mechanism, and multiple half key rings as attachment points as part of the attachment assembly, and a label area with labels.

FIG. 20 shows a key holder assembly wherein the first tier key holder is connected to a number of second tier key holders, demonstrating the tiered structure of the key holders.

FIG. 21 shows another key holder assembly wherein the first tier key holder is connected to a number of second tier key holders, demonstrating the tiered structure of the key holders. The carabiners and a snap hook are used as the attachment points. Each label area contains one label.

FIG. 22 shows a front view of a key holder having a round label area.

FIG. 23 shows a front view of a key holder having a hexagonal label area.

FIG. 24 shows a perspective view of a key holder having a labeling block with a dodecahedron shape wherein the half key rings are attach to the middle of the pentagonal facets.

FIG. 25 shows the schematic tiered structure of the property keys in an apartment building.

FIG. 26 shows the schematic tiered structure of the property keys in multiple multi-family properties, illustrating the tiered relationship of the keys.

FIG. 27 shows the schematic tiered structure of the property keys in a commercial building, building, illustrating the tiered relationship of the keys.

### DESCRIPTION OF THE PREFERRED EMBODIMENTS

The preferred embodiments of the present invention will now be described with reference to the drawings. Identical elements in the various figures are identified, as far as possible, with the same reference numerals. Such embodiments are provided by way of explanation of the present invention, which is not intended to be limited thereto. In fact, those of ordinary skill in the art may appreciate upon reading the present specification and viewing the present drawings that various modifications and variations can be made thereto without deviating from the innovative concepts of the invention.

For clarity purposes, some identical elements in the same figure are not all marked. Marking of one of the identical elements serves as an indication for the reference to the other elements.

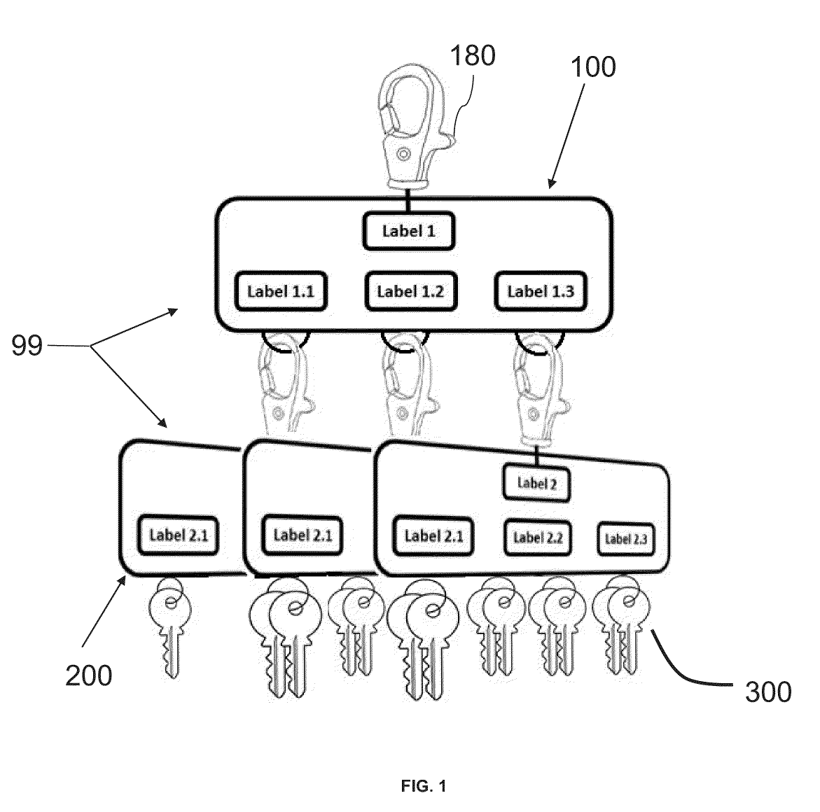

FIG. 1 shows a two-tiered key holder assembly 99 wherein the first tier comprises a first tier key holder 100 and the second tier comprises of a number of second tier key holders 200. The second tier key holders 200 attach to the first tier key holder 100 via fastening mechanisms. The structure of the key holder assembly 99 resembles a tree.

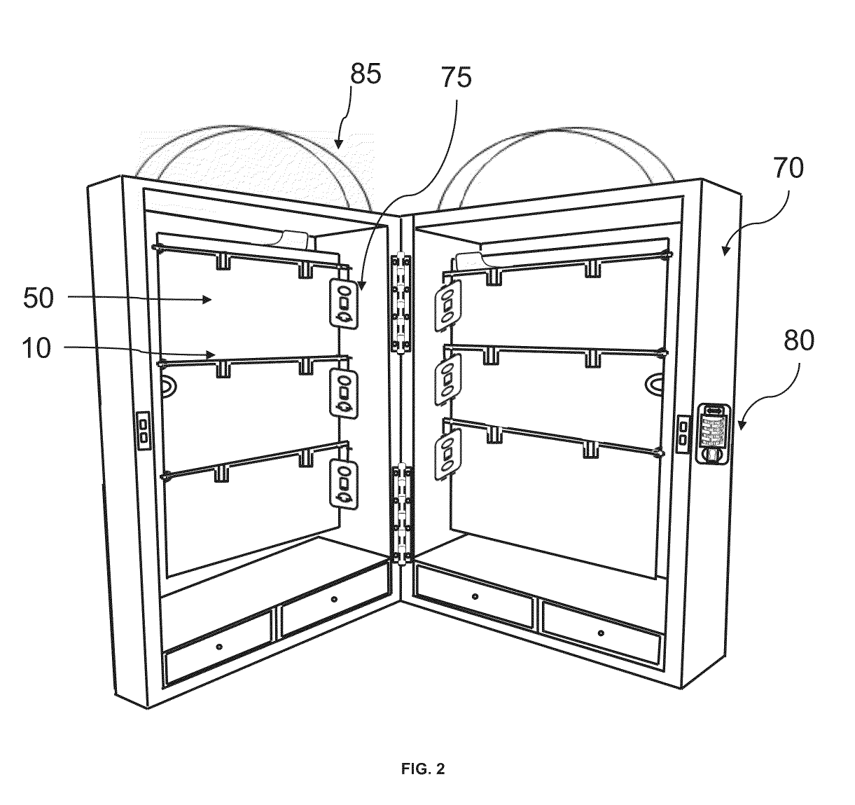

FIG. 2 shows a front view of a key organizer including a container box 70, swing sheets 50, swing hangers 10, a lock pad 80, and hinge pads 75. The container box shown in FIG. 2 contains two swing sheets 50. For each sheet 50, there are three swing hangers 10 that may be fastened onto the swing sheet 50. In general, a container box 70 may enclose multiple swing sheets 50 and each swing sheet 50 may attach to multiple swing hangers 10. There is at least a handle 85 attached to the top of the container box 70. The number of swing sheets 50 in a container box 70 and the number of swing hangers 10 attached to a swing sheet 50 may vary.

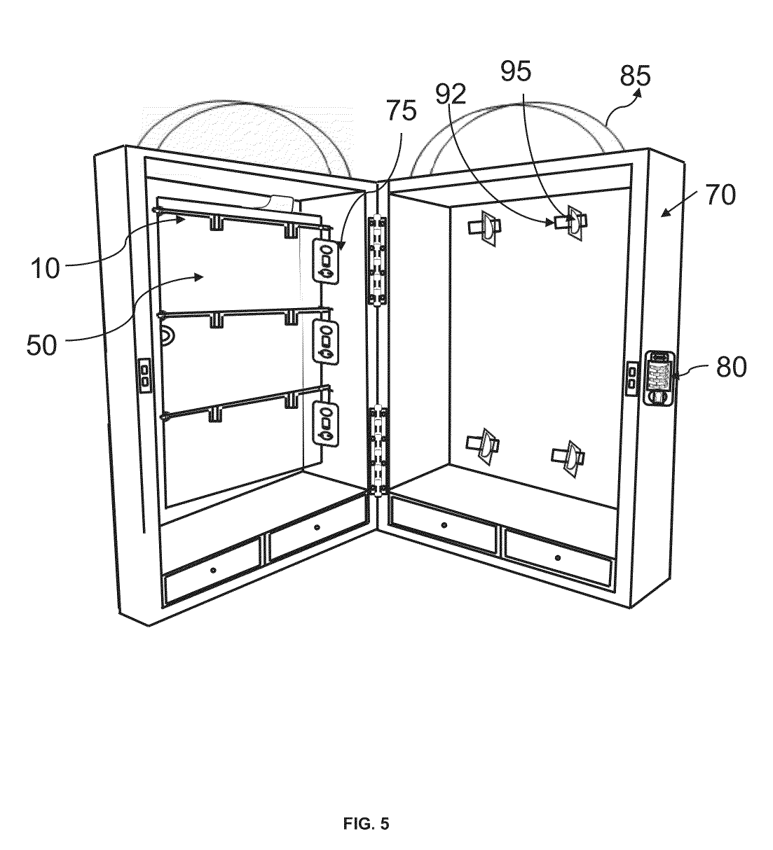

The container box 70 is preferably both portable and wall mountable. The handle 85 attached to the top of the container box 70 allows the container box 70 to be carried around. The container box 70 may contain wall mount mechanisms so that the container box 70 can be mounted onto the wall. Due to the design of the wall mount elements, which is shown in FIGS. 5-7, the container box can be easily removed from the wall and put back onto the wall.

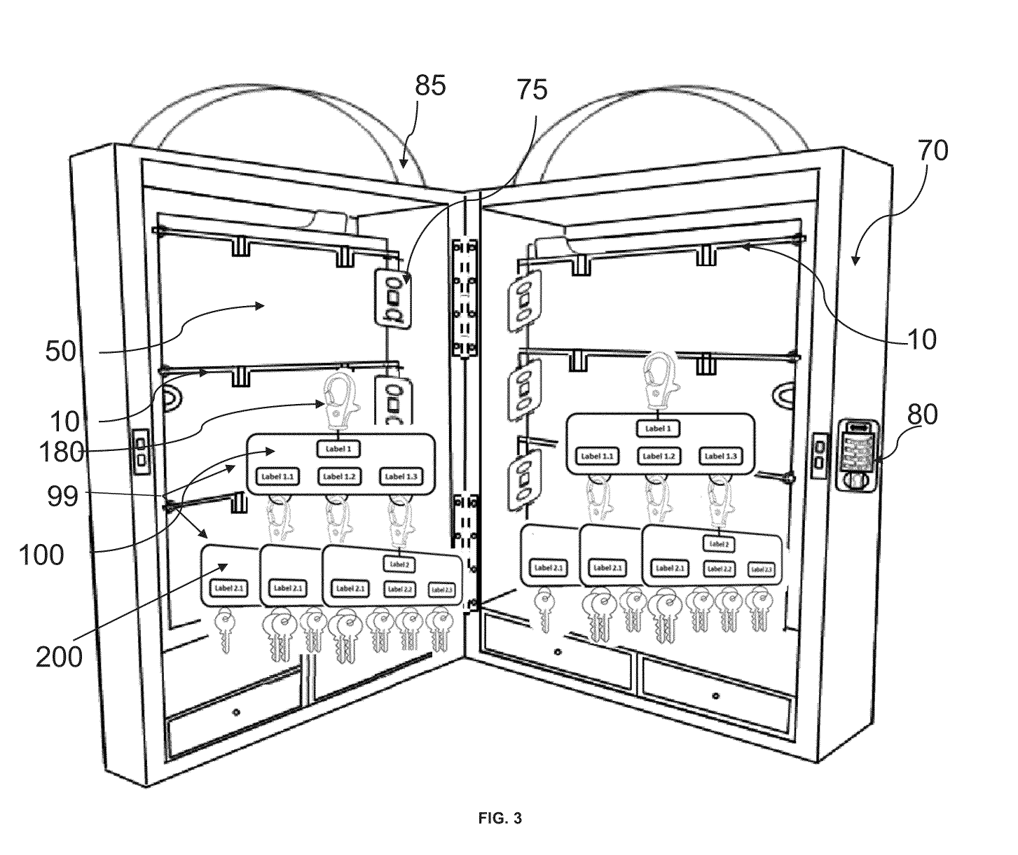

FIG. 3 shows a front view of a key organizing system which consists of a key organizer, and one or more key holder assemblies. As indicated in this figure, the key organizing system contains a container box 70, swing sheets 50, swing hangers 10, hinge pads 75, a lock pad 80, and key holder assemblies 99. As shown in FIG. 2, the container box 70 is capable of enclosing all the swing sheets 50, the swing hangers 10, the hinge pad 75, and the key holder assemblies 99. There is at least a handle 85 attached to the top of the container box 70. The first tier key holder 100 directly attaches to the swing hangers 10 via a releasable fastening mechanism 180 and a number of second tier key holders 200 attached to the first tier key holder 100 via fastening mechanisms 180. If a user wants to take a key holder assembly 99 out of the container box 70, he can easily release the fastening mechanism 180. Conveniently, the user can attach the key holder assembly 99 to his belt or bag via the fastening mechanism 180. The detailed structures of the various components are shown in later figures.

As shown in FIG. 3, the container box 70 may be locked by a lock pad 80, which prevents access to the interior of the container box 70 when locked. There could be different kinds of locks on the container box 70. For example, it can be a regular key lock, or it can be a combination lock.

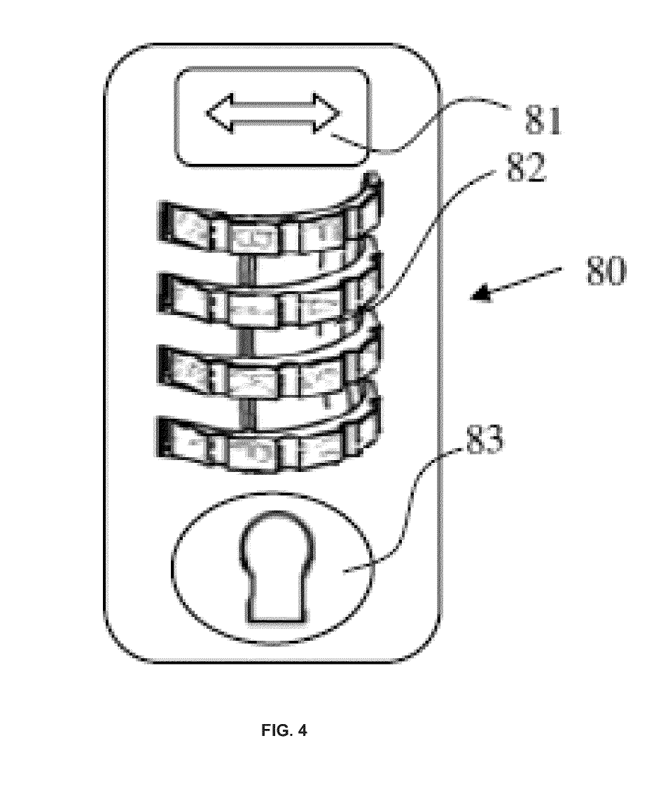

FIG. 4 shows a front view of the lock pad 80, serving as an example for the lock for the container box 70. The lock pad 80 has a fastening button 81, a combination lock 82, and a key hole 83. The fastening button 81 can be pushed to the left to close the front and back covers of the container Box. It can also be pushed to the right to open the front and back covers of the container box 70. A combination lock 82 can use a three or more digit codes to lock the container box 70 securely. The key hole 83 can also be used to lock and unlock the container box 70 with a key.

FIG. 5 shows a front view of a key organizer including a container box 70, a swing sheet 50, swing hangers 10, handle 85, hinge pads 75, a lock pad 80, and wall mounts for the container box 70. There are a plurality of rectangular holes 92 on the back of the container box 70. The visible wall mount element is the screw caps 95. Please note that it doesn't have to be a rectangular hole 92, it can be a narrow oval shape as long as the width and height of the hole are of different lengths so that the screw cap at some angle can't pass through.

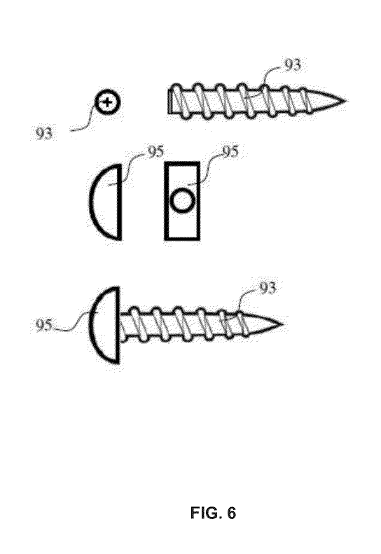

FIG. 6 shows the wall mounting screw 93 and screw cap 95. The top panel of this figure shows the top and side views of the screw 93. The middle panel of this figure shows the side and top views of the screw cap 95. The lower panel shows a side view of the screw 93 and the screw cap 95 when the two parts are attached.

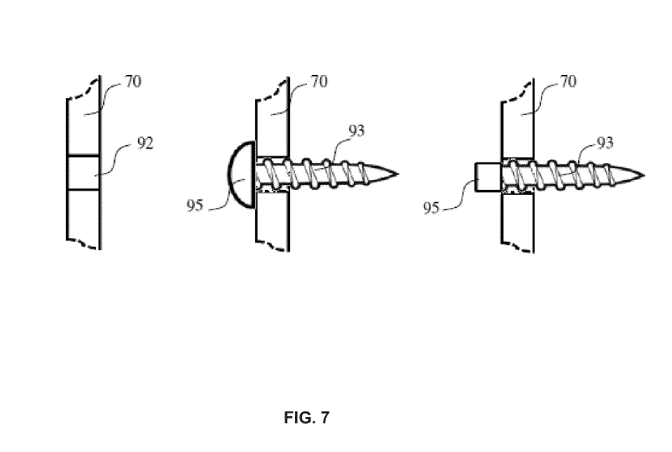

FIG. 7 shows a side view of how the wall mount works. The left panel of this figure shows side view of the rectangular hole 92 on the back of the container box 70. The middle panel shows the screw 93 threaded through the rectangular hole 92 and the screw cap 95 being turned so that the screw cap 95 cannot pass through the rectangular hole 92. The right panel shows the screw 93 threaded through the rectangular hole 92 and the screw cap 95 being turned so that the screw cap 95 can pass through the rectangular hole 92.

As shown in FIG. 6, the screw cap 92 has a round hole which has internal threads. The internal threads matches the external threads of the screw 93, which is preferably a Phillips screw. Thus the screw cap 92 can be screwed onto the Phillips screw 93, as shown in the lower panel of FIG. 6.

FIG. 7 shows how the container box 70 can be securely mounted onto the wall and how it can be easily removed. Referring to FIGS. 5-7, the following are the steps to mount the container box 70 onto the wall.

(1) First drill two Phillips screws 93 onto the wall and make sure that the spacing matches the distance between the top two rectangle holes on the back wall of the container box 70.

(2) Hang the container box 70 on the top two Phillips screws 93.

(3) Screw on the half-moon shaped screw caps 95 onto the top two Phillips screws 93.

(4) Drill two Phillips screws 93 onto the wall through the bottom two rectangle holes 92.

(5) Screw on the screw caps 95 onto the bottom two Phillips screws 93.

(6) To securely mount the container box 70, the user will turn the screw caps 92 so that the screw cap 95 and the rectangle hole 92 are orthogonal to each other. Since the length of the screw cap 95 is more than the width of the rectangle hole 92, the container box 70 cannot be removed easily by pulling on the container box 70.

(7) To remove the container box 70, simple turn the screw cap 95 ninety degrees so that the length of the screw cap 95 is aligned with the length of the rectangle hole 92. Since the length of the screw cap 95 is less than the length of the rectangle hole 92, the container box 70 can be easily removed.

Once the container box 70 is locked either with a key or through the combination lock, the container box 70 cannot be removed easily by anyone due to the locking mechanism of the screw caps 95. But when the container box 70 is unlocked, it is very easy to remove the container box 70 by turning the screw caps 95 by ninety degrees.

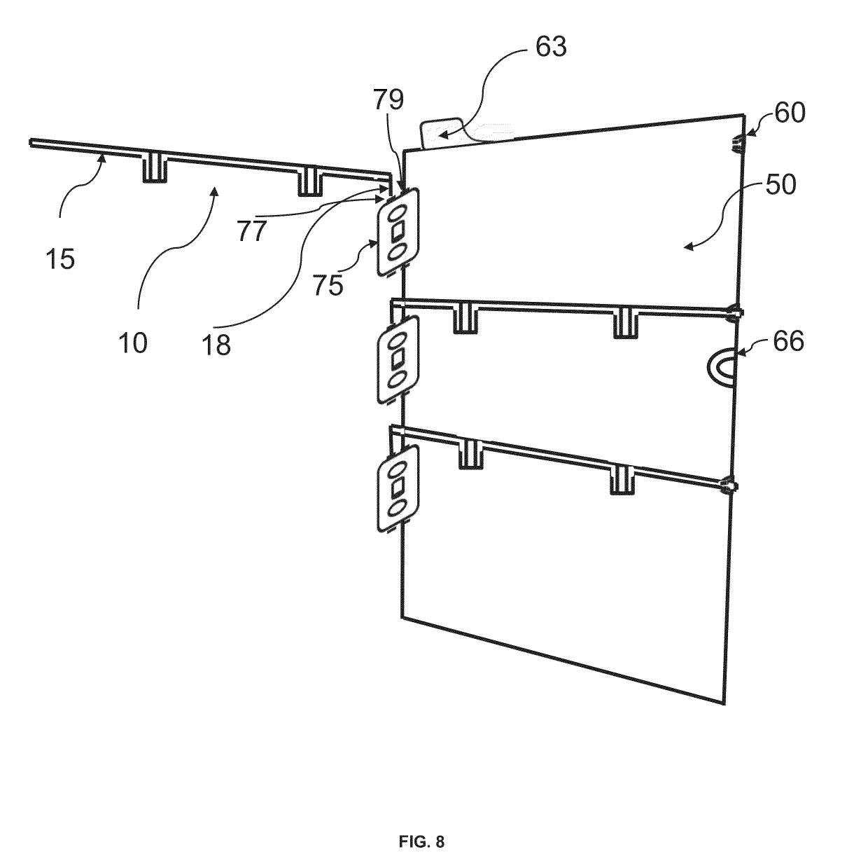

FIG. 8 shows a front view of a swing sheet 50, three hinge pads 75, and three swing hangers 10, wherein the swing hangers 10 are attached to first hinges 77, and the swing sheets 50 attach to second hinges 79. A first hinge 77 and a second hinge 79 may be disposed on a same hinge pad 75. The swing hanger 10 includes a connecting frame 18 and a hanger rack 15, wherein the hanger rack 15 is preferably positioned horizontally and may pivot horizontally against the swing sheet 50.

As shown in FIG. 8, a swing sheet 50 has a sheet label 63 on the top. The sheet labels from multiple swing sheets 50 may be staggered so that they can be seen by the user. In addition, there may also be a pulling hook 66 directly attached to the swing sheet 50. By pulling on the pulling hook 66, the swing sheet 50 swings and all of the swing hangers 10 being fastened to the swing sheet 50 will be forced to swing out with the swing sheet 50. The swing sheet 50 may also include a fastening hook 60. The hanger rack 50 may be releasably fastened to the swing sheet 50 via the fastening hooks 60. Each swing hanger 10 can swing out individually as shown in FIG. 8 since each swing hanger 10 has its own cylinder rod that rotates inside the hinge.

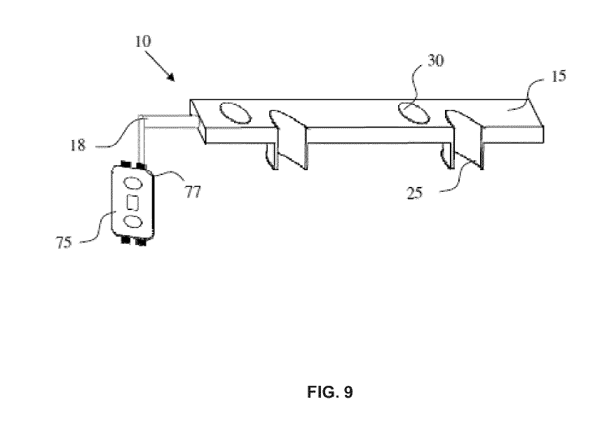

FIG. 9 shows a top perspective view of a swing hanger 10 swingably connected to a first hinge 77 disposed on a hinge pad 75. The swing hanger 10 includes a connecting frame 18 and a hanger rack 15. Along the length of the hanger rack 15, there are two attachment points, each attachment point comprises a half cylinder 25 and a hole 30. It should be noted that each swing hanger 10 can have multiple attachment points and the number of attachment points disposed on the hanger rack 15 may vary. The half cylinder 25 has the shape of half a cylinder empty on the inside. The hole 30 is a cylinder-shaped cut out on the hanger rack 15 and goes through the hanger rack. The one or more attachment points along the lengths of the hanger rack 15 form the hanger rack attachment assembly. The attachment assembly needs to comprise at least one attachment.

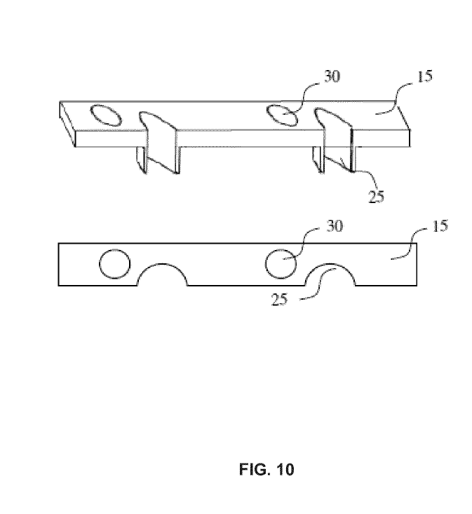

FIG. 10 shows the hanger rack 15 of a swing hanger 10 having a half cylinder 25 and a hole 30 as an attachment assembly. The top panel is a perspective view and the lower panel is a top view. The half cylinder 25 may protrude below the hanger rack 15, and the hole 30 goes vertically through the hanger rack 15.

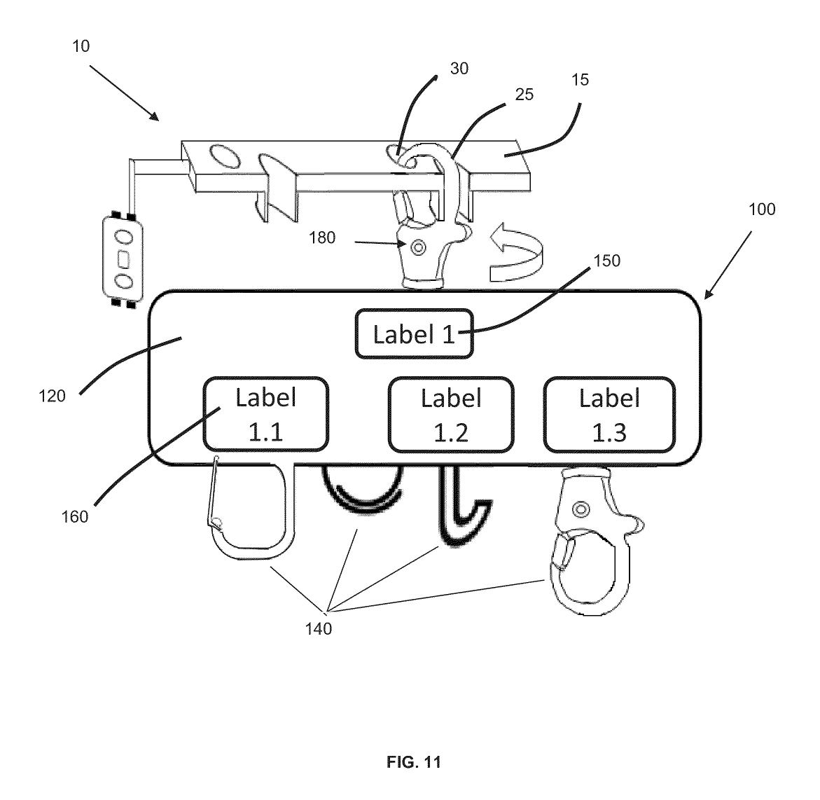

FIG. 11 shows a top perspective view of a swing hanger 10, a hinge pad 75, and a key holder 100 hanging from the hanger rack 15 of the swing hanger 10. The key holder 100 comprises a snap hook 180 which can be considered a fastening mechanism, a label area 120, and a key holder attachment assembly 140 positioned below the label area 120 and connected to the label area 120. The snap hook 180 releasably fastens the key holder 100 to the attachment assembly—the half cylinder 25 and the hole 30—of the swing hanger 10. As shown in FIG. 9-11, the fastening mechanism—the snap hook 180—of the key holder 100 attaches to the attachment —the half cylinder 25 and the hole 30—of the hanger rack 15 and conforms to the shape of the attachment point of the hanger rack 15 in a manner which minimizes movement of the fastening mechanism of the key holder 100 in relation to the hanger rack 15. In particular, as shown in FIG. 11, the tip of the snap hook 180 goes through the hole 30 and the snap hook 180 fits flush into the half cylinder 25 of the swing hanger 10. This prevents the snap hook 180 from rotating freely or shifting on the swing hanger 10 even if the container box 70 is turned upside down.

In the current embodiment, the portion of the snap hook 180 that is in contact with the half cylinder 25 preferably matches the size of the half cylinder 25. As a result, there is little movement allowed for the snap hook 180. The half cylinders 25 protrude downwards below the hanger rack 15 to further limit the horizontal movement of the snap hook 180. The snug attachment of the snap hook 180 onto the swing hanger 10 is important because the keys on the key holder 100 might weigh differently, which would otherwise have resulted in a tilted key holder 100. This tilting will create a messy look for the key structure that is created by stacking multiple key holders 100 in a tiered manner. The snug attachment of the snap hook 180 onto the swing hanger 10 prevents the key holder 100 from tilting vertically despite the varying weight of the keys. It should also be noted that it is not a strict requirement that the half cylinder 25 protrudes below the hanger rack 15. As long as the general goal of minimum movement for the fastening mechanism can be achieved, the half cylinder 25 may be even with the hanger rack 15. Please also note that even though the snap hook 180 is locked in place, the key holder 100 is free to rotate horizontally, but it cannot tilt vertically. The free rotation allows the key holder 100s to be packed together like sheets of paper.

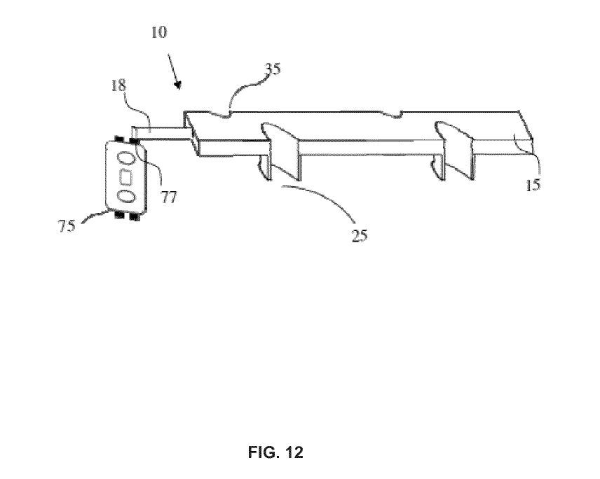

FIGS. 10 and 11 show another possible embodiment of the hanger rack attachment assembly. The attachment assembly that can be used on the swing hangers 10 can have different designs. Such alternative designs are shown in FIGS. 12-14.

FIG. 12 shows a top perspective view of a swing hanger 10 swingably connected to a first hinge 77 disposed on a hinge pad 75. The swing hanger 10 includes a connecting frame 18 and a hanger rack 15. Along the length of the hanger rack 15, there are two attachment points, each attachment point comprises a half cylinder 25 and a notch 35. Here, the attachment assembly of the hanger rack 15 comprises two attachment points. The attachment assembly needs to comprise at least one attachment.

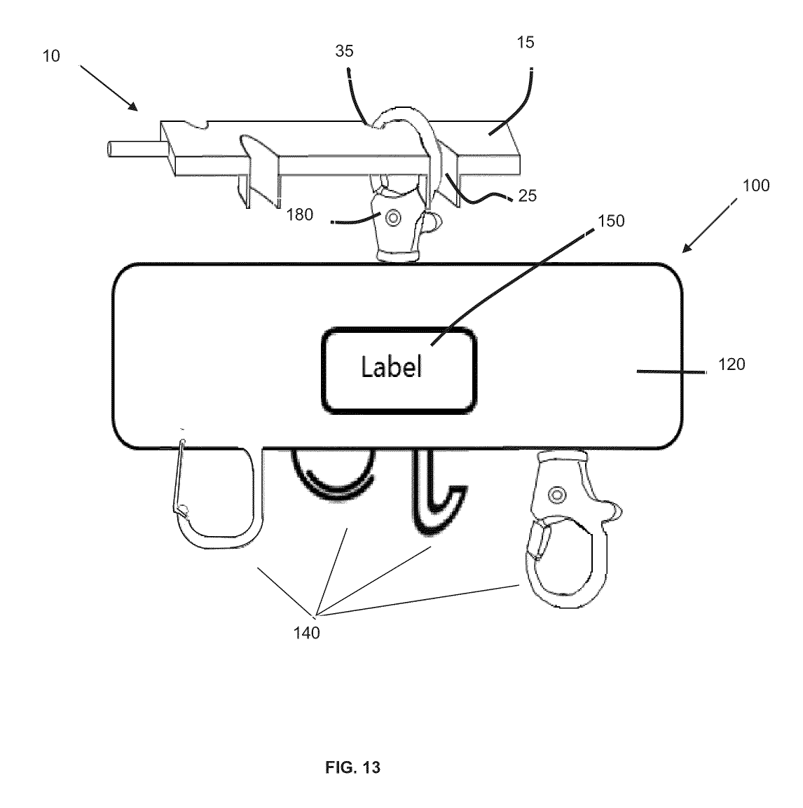

FIG. 13 shows a top perspective view of a swing hanger 10, a hinge pad 75, and a key holder 100 hanging from the hanger rack 15 of the swing hanger 10. The key holder 100 comprises a snap hook 180, which can be considered a fastening mechanism, a label area 120, and a key holder attachment assembly 140 positioned below the label area 120 and connected to the label area 120. The snap hook 180 releasably fastens the key holder 100 to the attachment assembly—a half cylinder 25 and a notch 35—of the swing hanger 10. The combination of the half cylinder 25 and the notch 35 performs similar functions as the combination of the half cylinder 25 and the hole 30 shown in FIG. 11. The fastening mechanism—the snap hook 180—of the key holder 100 attaches to the attachment assembly—the half cylinder 25 and the notch 35—of the hanger rack 15 and conforms to the shape of the attachment point n a manner which minimizes movement of the fastening mechanism in relation to the hanger rack 15.

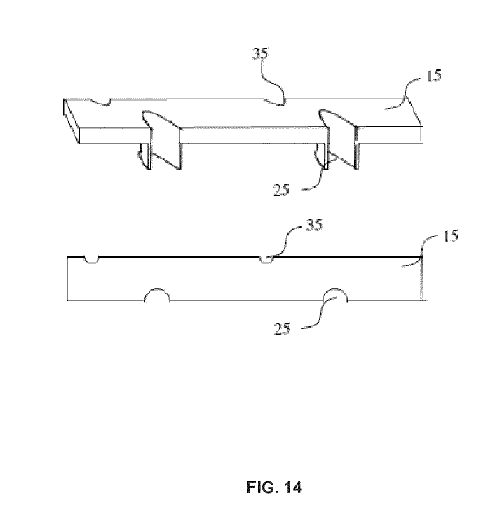

FIG. 14 shows the hanger rack 15 of a swing hanger 10 having two attachment points, each having a half cylinder 25 and a notch 35 attachment assembly. The top panel is a perspective view, and the lower panel is a top view.

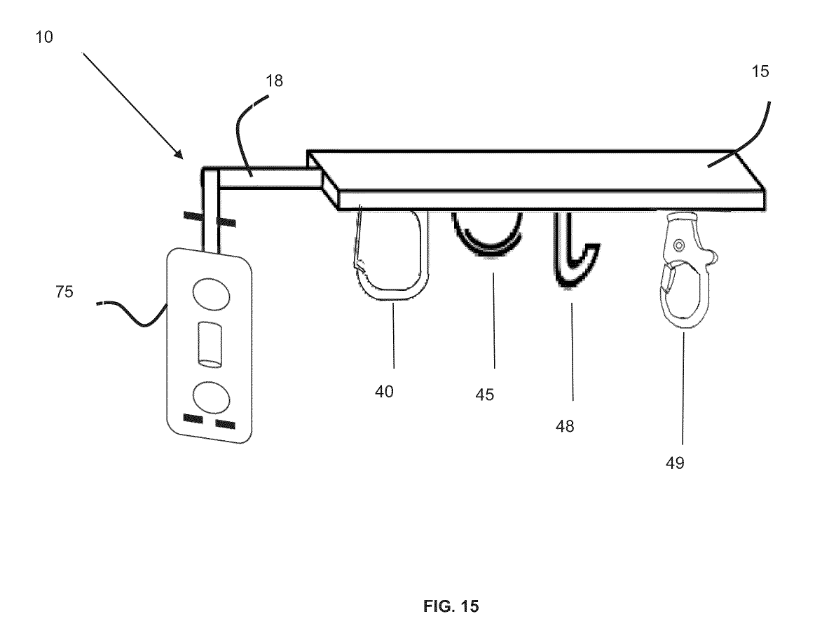

FIG. 15 shows top perspective view of a swing hanger 10 connected to a hinge pad 75, the hanger rack 15 of the swing hanger 10 having a carabiner 40, a half key ring 45, a key hook 48, and an upside down snap hook 49 as attachment points. A half key ring 40 is half a regular key ring. As shown in this figure, the half key rings 45, the key hook 48, and the snap hook 49 or carabiner 40 attach to the bottom of the hanger rack 15 and are capable of attaching key directly to the hanger rack 15 or attaching key holders or other objects. As indicated by FIGS. 9-15, the attachment assembly disposed on the hanger rack 15 may take many forms. The embodiments shown in FIGS. 9-15 serve only as examples.

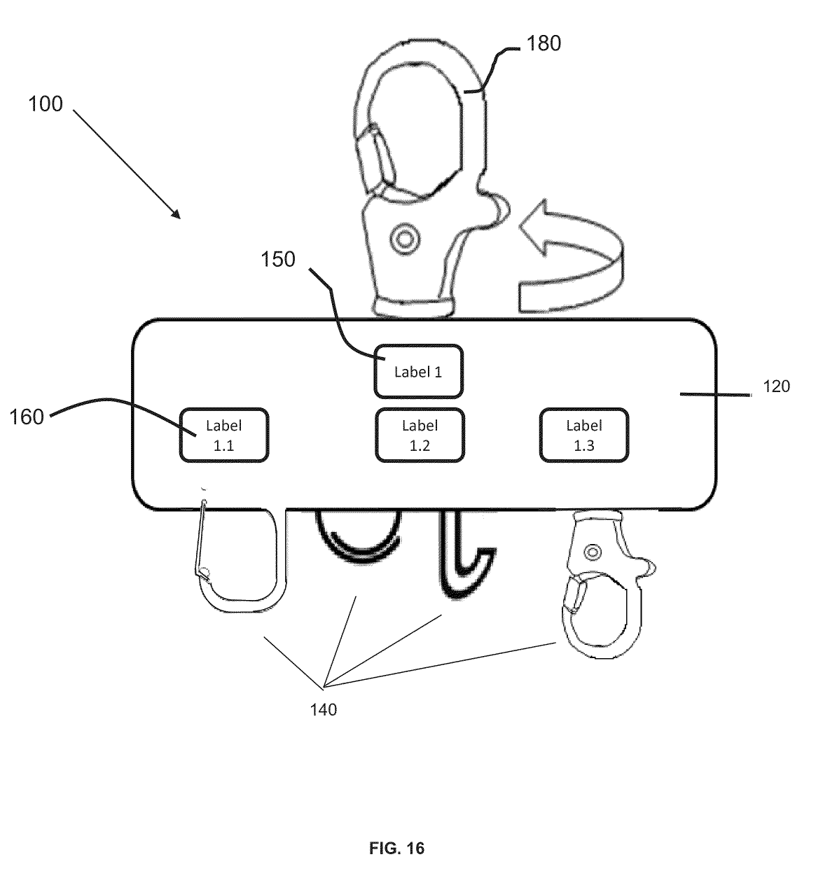

FIG. 16 shows a front view of a key holder 100, wherein the key holder 100 comprises: a label area 120 having at least one label; a snap hook 180, which can be considered a fastening mechanism attached to a top of the label area; and the key holder attachment assembly 140 attached to the bottom of the label area 120. The attachment assembly 140 is capable of attaching keys or other key holders to itself. Similar to the hanger rack attachment assembly in FIG. 15, the attachment points here include a snap hook, a half key ring, a key hook and a carabiner. The number of attachment points in the attachment assembly for a key holder 100 may vary according to the size of the key holder 100 and the needs of the user.

The label area 120 as shown in FIG. 16 can be a solid plate having at least one label. On the labels 150 and 160, a user can put adhesive labels which can be peeled off and replaced with a new label. On the adhesive labels, a description of the key or key holder can be written. There could be multiple labels 150 and 160. The label 150 preferably describes the entire key holder 100. The second labels 160 may be designated to specific keys or properties. In general, the labels describe the tiered relationship of the properties and the key. The design of the labels shown in this figure serves as an example and may vary according to the number and relationships of the properties.

The key holder 100 can be used to hang other key holders, or to hang keys directly.

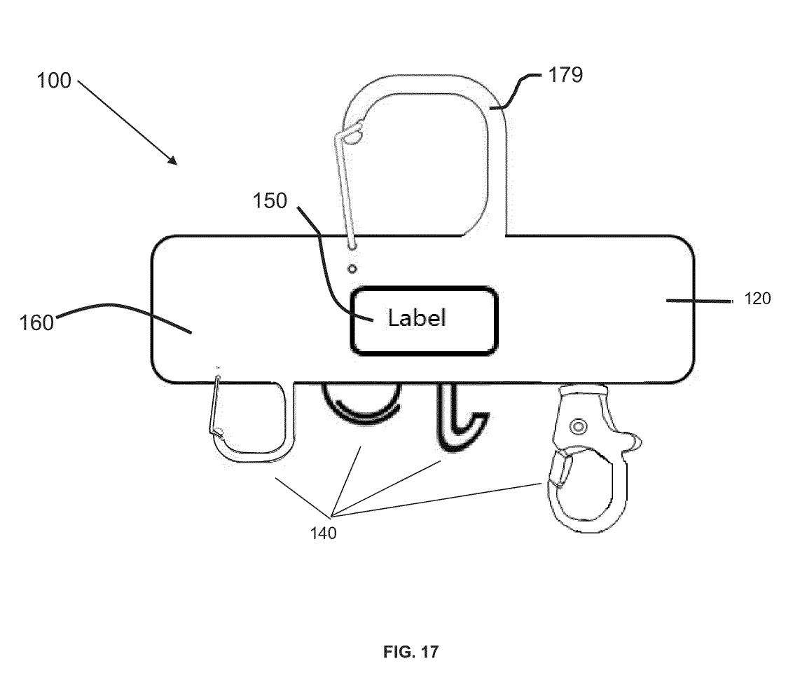

FIG. 17 shows a front view of a key holder 100, wherein the key holder 100 comprises: a label area 120 having at least one label; a carabiner 179, which can be considered a fastening mechanism attached to a top of the label area; and the key holder attachment assembly 140 attached to the bottom of the label area 120. This figure shows that the fastening mechanism doesn't have to be limited to a snap hook. Other forms of fastening mechanism are also supported.

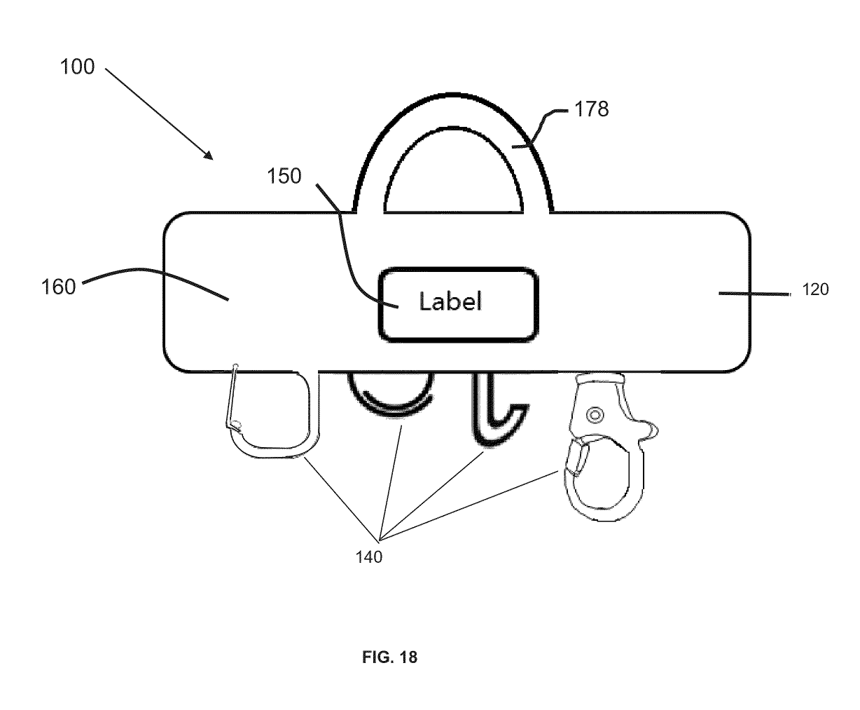

FIG. 18 shows a front view of a key holder 100, wherein the key holder 100 comprises: a label area 120 having at least one label; a loop 178, which can be considered a fastening mechanism attached to a top of the label area; and the key holder attachment assembly 140 attached to the bottom of the label area 120. This figure shows that the fastening mechanism doesn't have to be limited to a snap hook or a carabiner. Other forms of fastening mechanism are also supported. However, this key holder will not work with swing hanger in FIG. 9 or FIG. 12. It works with the swing hanger in FIG. 15.

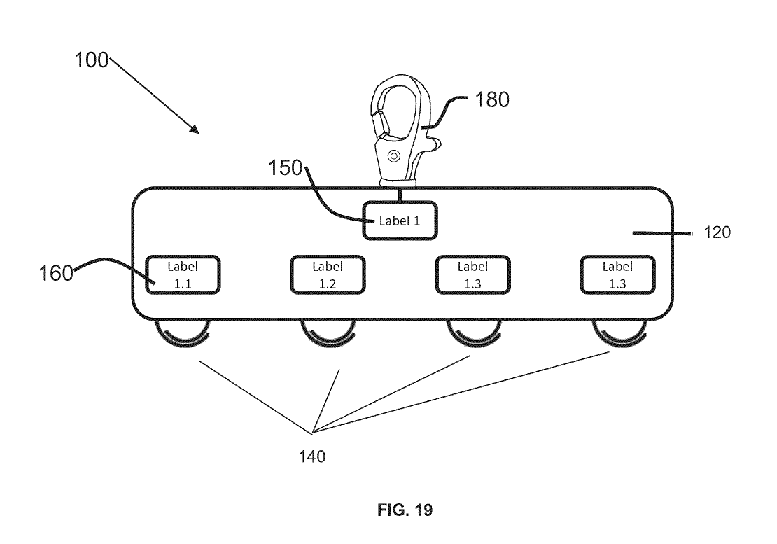

FIGS. 19 shows a front view of a key holder 100, wherein the key holder 100 comprises: a label area 120 having at least one label; a snap hook 180, which can be considered a fastening mechanism attached to a top of the label area; and the key holder attachment assembly 140 attached to the bottom of the label area 120. The key holder attachment assembly comprises half key rings. This figure shows that the key holder attachment assembly doesn't have to be limited to a snap hook or a carabiner. Other forms of fastening mechanism are also supported such as a half key ring.

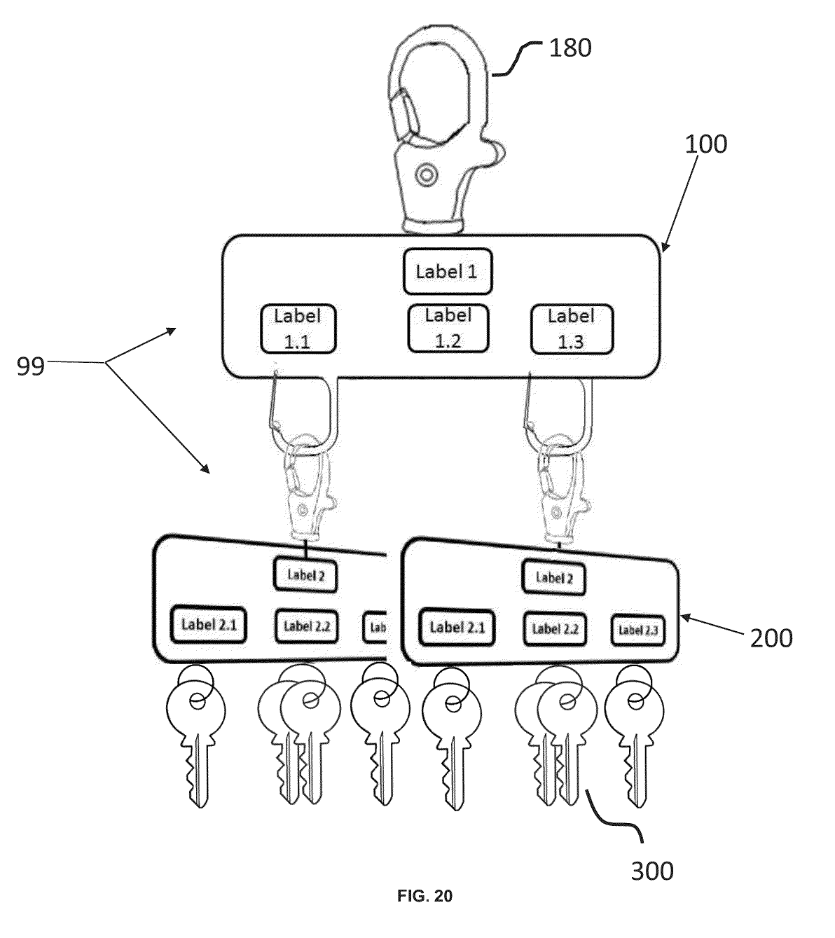

FIG. 20 shows a two-tiered key holder assembly 99 wherein the first tier comprises a first tier key holder 100 and the second tier comprises of a number of second tier key holders 200. The first tier key holder 100 uses a snap hook 180 as a fastening mechanism and carabiners as attachment points. The second tier key holders 200 attach to the first tier key holder 100 via fastening mechanisms, namely carabiners 179 in this figure. The structure of the key holder assembly 99 resembles a tree. The number of tiers a key holder assembly 99 represents the depth. The breadth of the key holder assembly 99 refers to the number of key holders on the same tier. The more key holders there are on the same tier, the more breadth the key holder assembly 99 has. There is no limit as to the breadth and the depth a key holder assembly 99 can have.

The key holder assembly 99 can be easily configured by manipulating the breadth and depths to closely represent the tiered structure of the keys via the fastening mechanisms. For instance, there might be multiple tiers of key holders to represent the multi-tiered structure of the keys. FIG. 20 shows a two-tiered key holder assembly with first key holder 100 hanging a number of second tier key holders 200. Any of the first tier key holder 100 and second tier key holders 200 in FIG. 20 can be replaced with another key holder that has different number of labels or different shapes. The keys 300 are hanging directly on the second tier key holders 200.

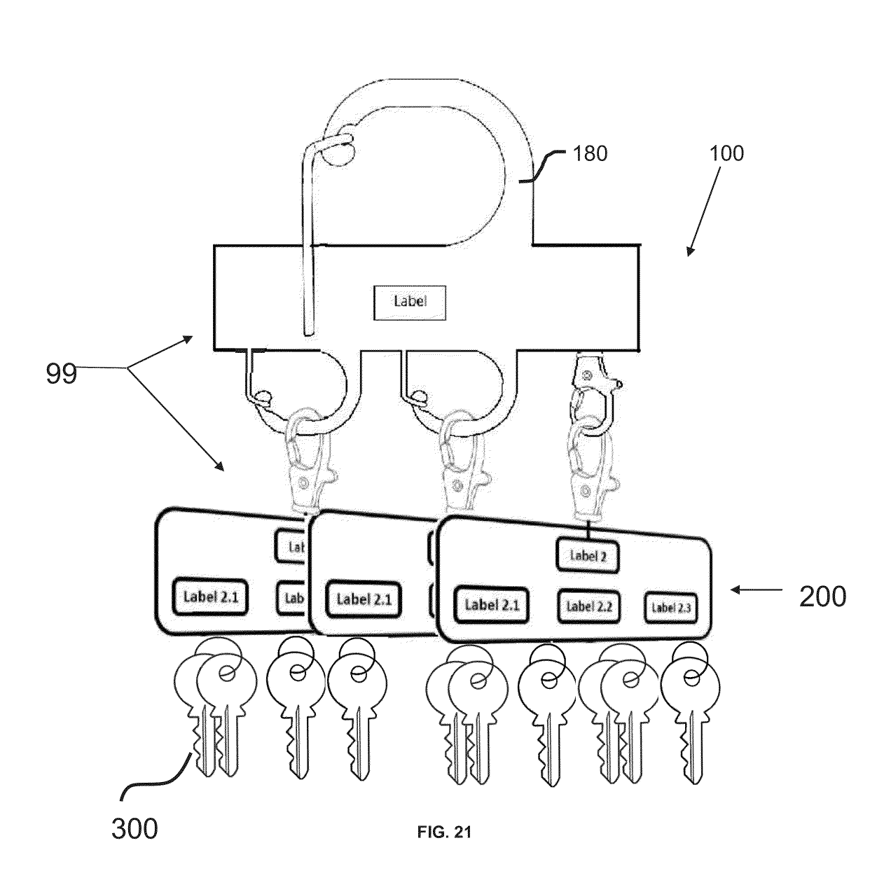

FIG. 21 shows a two-tiered key holder assembly 99 wherein the first tier comprises a first tier key holder 100 and the second tier comprises of a number of second tier key holders 200. The first tier key holder 100 uses a carabiner 179 as a fastening mechanism and a mixture of carabiner and snap hook as attachment points. The second tier key holders 200 attach to the first tier key holder 100 via fastening mechanisms, namely the loops 178 in this figure. This figure shows that there could be variations on the key holders to build a similar tree structure.

The label area 140 of the key holder 100 may adopt any shape such as but not limited to: rectangle, round, hexagon, or octagon.

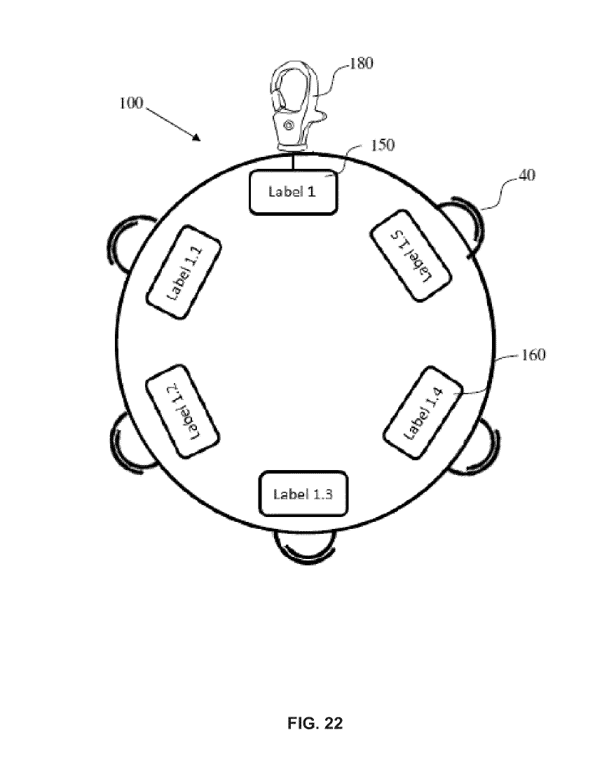

FIG. 22 shows a front view of a key holder 100 having a round label area 120. There are one first tier label 150 and a number of second tier labels 160 disposed on the label area 120 and half key rings 40 attached to the label area 120.

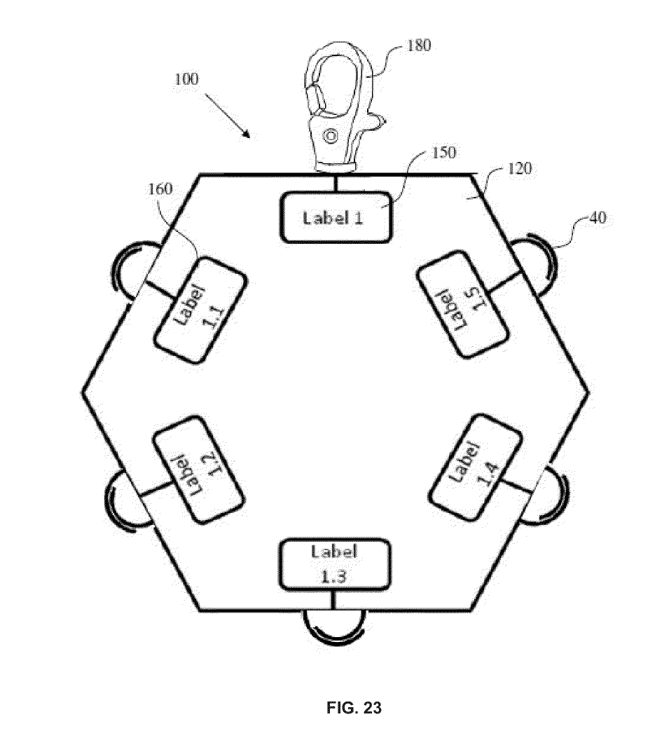

FIG. 23 shows a front view of a key holder 100 having a hexagonal label area 120. There are one first tier label 150 and a number of second tier labels 160 disposed on the label area 120 and half key rings 40 attached to the label area 120.

In addition, the label area 120 may be replaced by a labeling block with has a 3-D structure and serves essentially the same function as the label area 120. The labeling block may adopt any shape such as cylinder, hexagon prism, and polyhedrons.

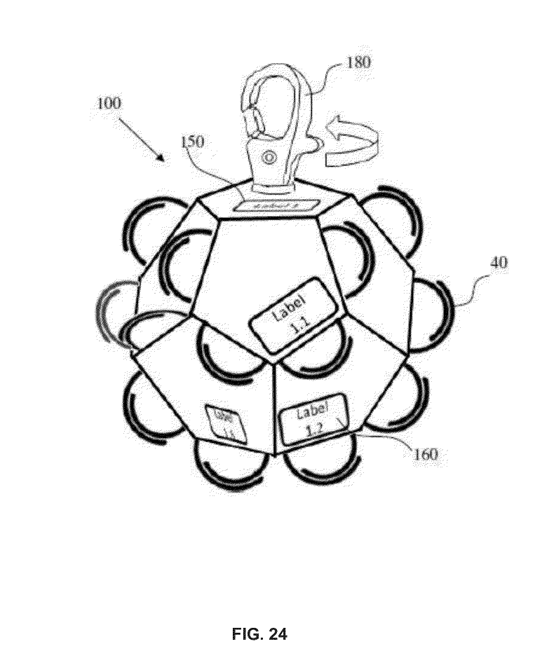

FIG. 24 shows a perspective view of a key holder 100 having a labeling block 125 with a dodecahedron shape wherein the half key rings 40 are attach to the middle of the pentagonal facets of the labeling block 125. There is one first tier label 150 and a number of second tier labels 160 disposed on the labeling block 125.

A few applications of the current invention are outlined below, but the key organizing system herein disclosed is not limited to just these applications.

Apartment Building

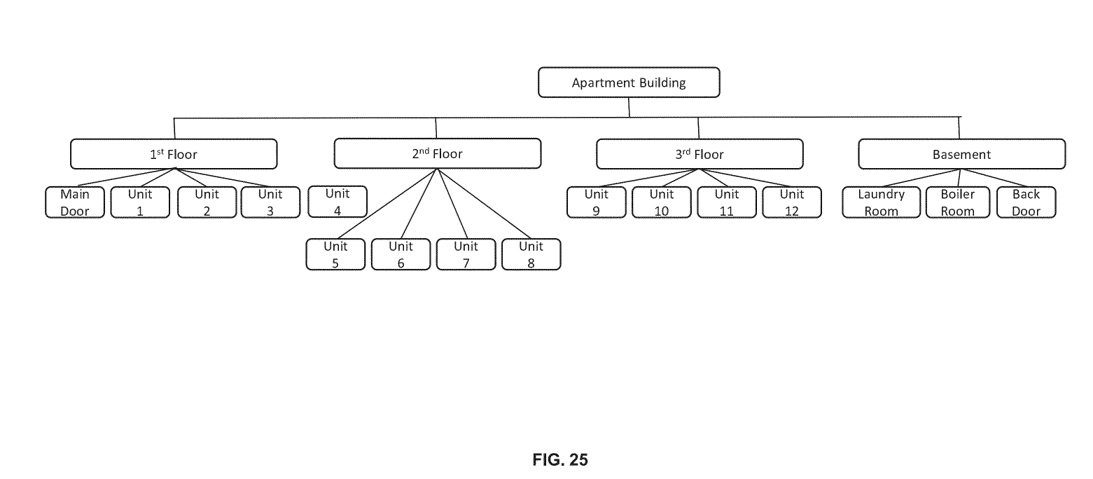

FIG. 25 shows the schematic tiered relationship of the properties in an apartment building, illustrating the tiered relationship of the keys.

An apartment building may have multiple floors, each floor may have multiple apartment units. The key organizing system can be configured to include two tiers of key holders 100, wherein the first tier represents the floors, and the second tier represents the units.

Group of Multi-Family Units

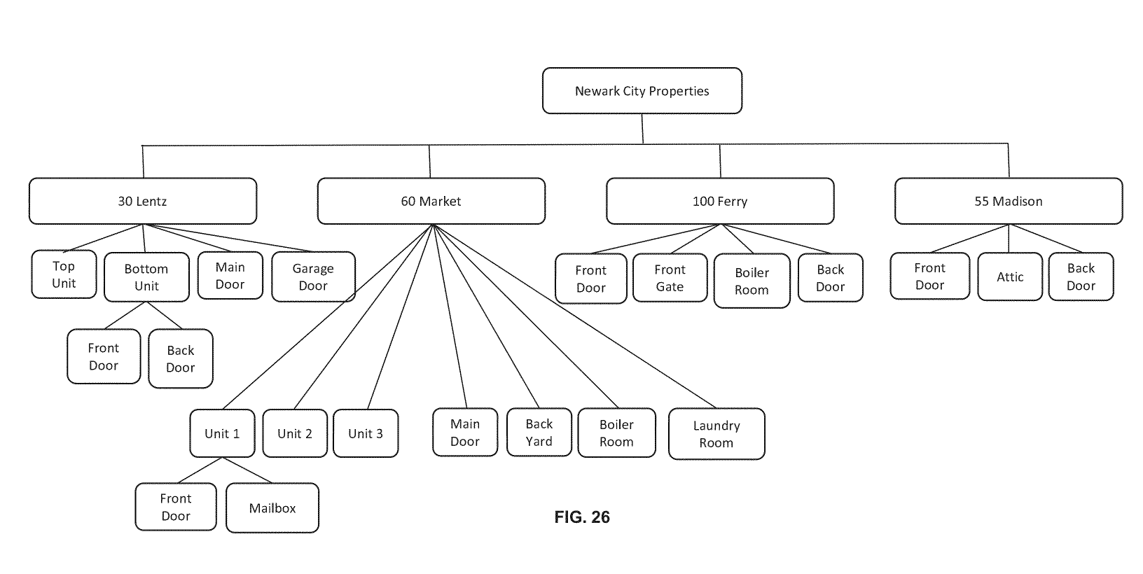

FIG. 26 shows the schematic tiered relationship of the properties in multiple multi-family properties, illustrating the tiered relationship of the keys.

This group may consist of multiple properties at different locations. Each property may have one or more rental units. The key organizing system can be configured to include two tiers of key holders 100. The first tier represents the multiple properties. The second tier represents the units.

Commercial Building

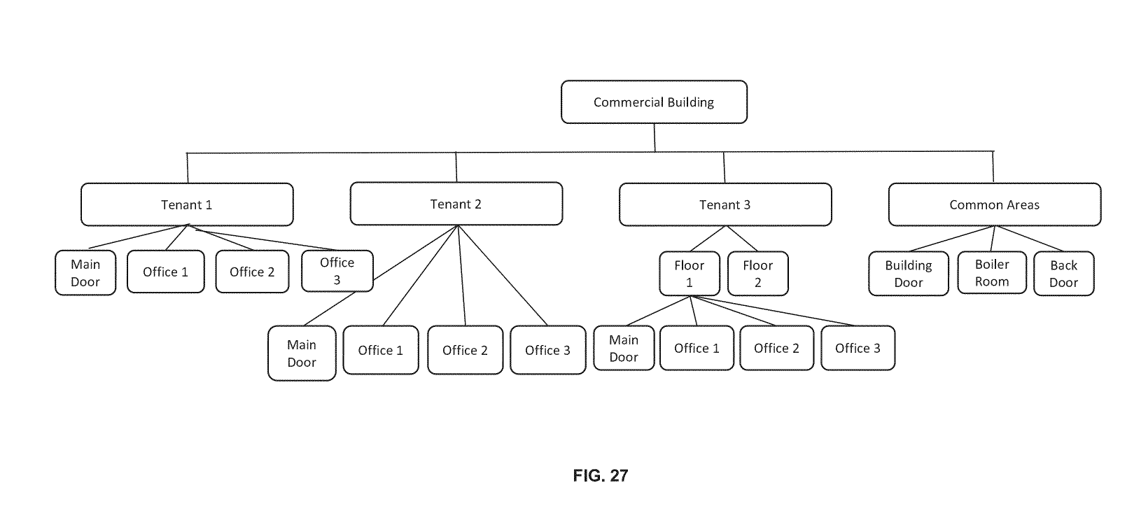

FIG. 27 shows the schematic tiered relationship of the properties in a commercial building, building, illustrating the tiered relationship of the keys.

A commercial building might have multiple tenants. Some tenants might occupy some portion of a floor, some tenants may occupy two floors. In this case, we can use tenants as the first tier. Each tenant might have different room keys. This would be the second tier. There might be three or more tiers depending on how the tenant organizes the keys.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A key holder assembly comprising:
a first tier key holder, the first tier key holder comprising:
a label area having at least one label;
a fastening mechanism; and
an attachment assembly having at least one attachment point.

2. The key holder assembly of claim 1, wherein the attachment assembly further comprises:
a plurality of attachment points.

3. The key holder assembly of claim 1, wherein the label area further comprises:
a plurality of labels.

4. The key holder assembly of claim 1, wherein the fastening mechanism of the first tier key holder is a snap hook, carabiner, loop or a combination thereof.

5. The key holder assembly of claim 1, further comprising:
a second tier key holder, the second tier key holder having:
a label area having at least one label;
a fastening mechanism; and
an attachment assembly having at least one attachment.

6. The key holder assembly of claim 5, wherein the fastening mechanism of the second tier key holder attaches to the attachment assembly of the first tier key holder.

7. The key holder assembly of 5, wherein the second tier key holder has a similar structure to the first tier key holder.

8. The key holder assembly of 5, wherein the fastening mechanism of the second tier key holder is a snap hook, a carabiner, a loop or a combination thereof.

9. The key holder assembly of claim 5, further comprising a plurality of second tier key holders, wherein each second tier key holder attaches to the attachment assembly of the first tier key holder.

10. The key holder assembly of claim 5, further comprising a plurality of tiers of key holders.

11. A key organizer comprising:
a first swing hanger having a hanger rack swingably connected to a first hinge, the hanger rack having a hanger attachment assembly disposed on the hanger rack, wherein
the hanger attachment assembly has at least one attachment.

12. The key organizer of claim 11, wherein
the hanger attachment assembly has a plurality of identical or different attachment points.

13. The key organizer of claim 11, further comprising:
a first swing sheet, the first swing sheet being capable of rotating horizontally around a second hinge, wherein
the hanger rack of the first swing hanger is capable of pivoting horizontally against the first swing sheet.

14. The key organizer of claim 13, wherein
the first swing sheet has a hanger fastening hook,
the hanger fastening hook releasably stabilizes the hanger rack to keep the hanger rack parallel to and flush against the swing sheet.

15. The key organizer of claim 13, further comprising:
a plurality of swing hangers having the same structure, wherein
each hanger rack of each swing hanger is capable of pivoting horizontally against the swing sheet,
each hanger rack of each swing hanger is capable of being held in parallel alignment to one another when held flush against a same side of the swing sheet.

16. The key organizer of claim 13, further comprising:
a second swing sheet having the same structure as the first swing sheet; and
a second group of swing hangers having the same structure as the first swing hanger,
wherein each hanger rack of each second swing hanger aligns parallel to one another when held flush against a same side of the second swing sheet.

17. The key organizer of claim 13, further comprising:
a plurality of swing sheets having the same structure, wherein
the swing sheets are capable of being held in parallel alignment to one another.

18. The key organizer of claim 11, further comprising
a container box enclosing a plurality of swing hangers.

19. The key organizer of claim 18, further comprising
a lock pad, wherein
the lock pad locks the container box, preventing access to an interior of the container box.

20. The key organizer of claim 18, further comprising
a wall mount capable of attaching the container box to a wall.

21. The key organizer of claim 20, wherein
there are holes on a back of the container box,
and the wall mount comprises:
screws threaded through the holes and attached to a wall,
and screw caps capable of attaching to heads of the screws, wherein
turning the screw caps allows the screw caps to alternate between being able to pass through the holes and not being able to pass through the holes.

22. The key organizer of claim 21, further comprising
a container box enclosing the swing hanger, the hinge pad, and the swing sheet;
a lock pad capable of locking the container box and preventing access to an interior of the container box; and
a wall mount capable of attaching the container box to a wall.

23. A key organizing system comprising:
a key organizer wherein the key organizer comprises,
at least one swing hanger on a hinged swing sheet,
wherein the hinged swing sheet is contained within a container box having a locking mechanism; and
a key holder assembly having a plurality of tiered key holders,
wherein each key holder has at least one label area having a markable label and wherein each of the plurality of tiered key holders has a fastening mechanism for attachment.

24. The key organizing system of claim 23, wherein
the fastening mechanism of the first tier key holder of the key holder assembly attaches to the hanger attachment assembly of the key organizer and conforms to the hanger attachment assembly in a manner which minimizes movement of the fastening mechanism in relation to the hanger rack.

25. The key organizing system of claim 23, further comprising:
a plurality of key holder assemblies, wherein
each key holder assembly attaches to a swing hanger attachment.

26. A key holder assembly comprising:
a plurality of tiered key holders,
wherein each of the plurality of tiered key holders have a fastening mechanism and an attachment assembly,
wherein one of the plurality of tiered key holders attaches to the attachment assembly of another one of the plurality of tiered key holders by way of the fastening mechanism; and
a label area located on each of the plurality of tiered key holders,
wherein the label area has a label disposed on the surface of the label area.

27. The key holder assembly of claim 26 wherein the fastening mechanism is a snap hook, carabiner, loop or the like or any combination thereof.

28. The key holder assembly of claim 26 wherein the label is removable.
